(19) United States
(12) Patent Application Publication
(10) Pub. No.: US 2017/0013618 A1
(43) Pub. Date: Jan. 12, 2017

(54) LOW LATENCY TRANSMISSION METHOD AND APPARATUS

(71) Applicant: Electronics and Telecommunications Research Institute, Daejeon (KR)

(72) Inventor: Eun-Jeong SHIN, Daejeon (KR)

(21) Appl. No.: 15/205,697

(22) Filed: Jul. 8, 2016

(30) Foreign Application Priority Data
Jul. 10, 2015 (KR) 10-2015-0098684
Jul. 8, 2016 (KR) 10-2016-0086664

(51) Int. Cl. H04W 72/04; H04L 5/00

(52) U.S. Cl. CPC H04W 72/0446; H04W 72/042; H04L 5/0048; H04W 72/0413; H04L 5/0096; H04L 5/0053

(57) ABSTRACT

A base station supports a low latency mode of a terminal through a legacy downlink subframe transmitted in a first transmission time interval (TTI) unit in a downlink primary component carrier, and transmits control information and low latency downlink data to the terminal operated in the low latency mode through a downlink subslot transmitted in a second TTI unit in a downlink secondary component carrier.

### CROSS-REFERENCE TO RELATED APPLICATION

This application claims priority to and the benefit of Korean Patent Application Nos. 10-2015-0098684, and 10-2016-0086664 filed in the Korean Intellectual Property Office on Jul. 10, 2015, and Jul. 8, 2016 the entire contents of which are incorporated herein by reference.

### BACKGROUND OF THE INVENTION

(a) Field of the Invention

The present invention relates to a low latency transmission method and apparatus. More particularly, the present invention relates to a low latency transmission method and apparatus capable of supporting a low latency service on the basis of a legacy long term evolution (LTE) system while supporting the legacy LTE system.

(b) Description of the Related Art

A communication technology has been developed so as to support compatibility with the previous technology and support the next technology. In a process in which a fourth-generation (4G) long term evolution (LTE) system is evolved to fifth-generation (5G), the 4G LTE system should be basically supported and a 5G technology should be combined with the 4G LTE system.

In the 5G technology, a higher data rate and a low latency technology have been demanded. The low latency technology is a technology of decreasing a time required for a base station or a terminal to transmit data and then receive a response. The low latency technology requires a new data rate and response speed while maintaining compatibility with the existing 4G technology. The present invention suggests a control scheme and a low latency frame structure between a base station and a terminal capable of supporting a low latency service while supporting existing LTE on the basis of an LTE communication scheme, which is a 4G communication scheme.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a low latency transmission method and apparatus having advantages of supporting a low latency service while maintaining compatibility with a technology of an existing long term evolution (LTE) system.

An exemplary embodiment of the present invention provides a low latency transmission method in a base station. The low latency transmission method includes: supporting a low latency mode of a terminal through a legacy downlink subframe transmitted in a first transmission time interval (TTI) unit in a downlink primary component carrier; and transmitting control information and low latency downlink data to the terminal operated in the low latency mode through a downlink subslot transmitted in a second TTI unit in a downlink secondary component carrier.

The second TTI unit may be shorter than the first TTI unit.

A sampling rate in the downlink secondary component carrier may be set to an integer times of a sampling rate in the downlink primary component carrier, and a sub-carrier interval and a system bandwidth in the downlink secondary component carrier may be set to integer times of a sub-carrier interval and a system bandwidth in the downlink primary component carrier, respectively.

A time length of the legacy downlink subframe may include a plurality of downlink subslots, and each of the plurality of downlink subslots may include a plurality of short symbols, and the transmitting may include allocating a cell-specific reference signal to a first symbol among the plurality of short symbols.

The transmitting may further include allocating a terminal-specific reference signal to the remaining symbols except for the first symbol among the plurality of short symbols.

The low latency transmission method may further include: transmitting a synchronization signal and system information through the downlink primary component carrier.

The supporting may include transmitting low latency information through a control channel of the legacy downlink subframe, and the low latency information may include at least one of a carrier frequency of a secondary component carrier, the number of symbols within the second TTI unit, a sub-carrier interval, a sampling rate, and a system bandwidth.

The low latency transmission method may further include: transmitting a low latency connection release requesting turn-off the low latency mode of the terminal through the legacy downlink subframe or the downlink subslot.

The low latency transmission method may further include: receiving a low latency connection release for informing the base station of turn-off of the low latency mode from the terminal through a legacy uplink subframe transmitted in the first TTI unit from the terminal or an uplink subslot transmitted in the second TTI unit from the terminal.

The low latency transmission method may further include: receiving control information and low latency uplink data through an uplink subslot transmitted in the second TTI unit in an uplink secondary component carrier from the terminal.

A time length of a legacy uplink subframe transmitted in the first TTI unit may include a plurality of uplink subslots, and each of the plurality of uplink subslots may include a plurality of short symbols, and the receiving may include receiving a sounding reference signal (SRS) through the last short symbol of the last uplink subslot among the plurality of uplink subslots.

Another exemplary embodiment of the present invention provides a low latency transmission method in a terminal. The low latency transmission method includes: receiving low latency information for a low latency mode of the terminal through a legacy downlink subframe transmitted in a first TTI unit in a downlink primary component carrier from a base station; and obtaining control information and low latency downlink data through a downlink subslot transmitted in a second TTI unit in a downlink secondary component carrier using the low latency information.

The low latency transmission method may further include: transmitting control information and low latency uplink data to the base station through an uplink subslot transmitted in the second TTI unit in an uplink secondary component carrier from the terminal.

The transmitting of the control information and the low latency uplink data to the base station may include transmitting an SRS through the last short symbol of the last uplink subslot among a plurality of uplink subslots included in a time length of a legacy uplink subframe transmitted in the first TTI unit.

A time length corresponding to the legacy downlink subframe may include a plurality of downlink subslots.

A sampling rate in the downlink secondary component carrier may be set to an integer times of a sampling rate in the downlink primary component carrier, and a sub-carrier interval and a system bandwidth in the downlink secondary component carrier may be set to integer times of a sub-carrier interval and a system bandwidth in the downlink primary component carrier, respectively.

The low latency information may include at least one of a carrier frequency of a secondary component carrier, the number of symbols within the second TTI unit, a sub-carrier interval, a sampling rate, and a system bandwidth.

The obtaining may include: receiving position and size information of a common downlink control information (DCI) region and position and size information of terminal-specific DCI within a control channel of the downlink subslot from the base station; and receiving common DCI and terminal-specific DCI on the basis of the position and size information of the common DCI region and the position and size information of the terminal-specific DCI.

Yet another exemplary embodiment of the present invention provides a low latency transmission apparatus. The low latency transmission apparatus includes a processor and a transceiver. The processor performs scheduling for transmitting data in a first TTI unit in a primary component carrier, performs scheduling for transmitting data in a second TTI unit in a secondary component carrier, and performs resource allocation for uplink and downlink physical channels for the primary component carrier and the secondary component carrier; and

The transceiver transmits data and uplink and downlink resource allocation information through the primary component carrier or the secondary component carrier. The second TTI unit is shorter than the first TTI unit.

A time length of one subframe may include a plurality of subslots, the first TTI unit may be set to the time length of the one subframe, and the second TTI unit may be set to a time length of one subslot, and the processor may allocate a cell-specific reference signal (CRS) to a first short symbol among a plurality of short symbols of each subslot in a downlink.

### BRIEF DESCRIPTION OF THE DRAWINGS

FIG. 1 is a view showing an example of a frame structure of a legacy long term evolution (LTE) system.

FIGS. 2 and 3 are views showing an example of a multi-component carrier supported by the legacy LTE system, respectively.

FIG. 4 is a view showing an example of a downlink subframe of a low latency system according to Table 1.

FIG. 5 is a view showing an example of a downlink subframe of a low latency system according to Table 2 and Table 3.

FIG. 6 is a view showing an example of an uplink subframe of a low latency system according to Table 1.

FIG. 7 is a view showing an example of an uplink subframe of a low latency system according to Table 2 and Table 3.

FIGS. 8 to 10 are views showing a low latency transmission method according to exemplary embodiments of the present invention, respectively.

FIGS. 11 to 14 are views showing a low latency service ending method according to an exemplary embodiment of the present invention, respectively.

FIG. 15 is a view showing a low latency transmission apparatus of a base station according to an exemplary embodiment of the present invention.

FIG. 16 is a view showing a low latency transmission apparatus of a terminal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and the claims, unless explicitly described to the contrary, the word “comprise” and variations such as “comprises” or “comprising”, will be understood to imply the inclusion of stated elements but not the exclusion of any other elements.

Throughout the present specification, a terminal may indicate a mobile terminal (MT), a mobile station (MS), an advanced mobile station (AMS), a high reliability mobile station (HR-MS), a subscriber station (SS), a portable subscriber station (PSS), an access terminal (AT), a user equipment (UE), or the like, and may include all or some of functions of the MT, the MS, the AMS, the HR-MS, the SS, the PSS, the AT, the UE, or the like.

In addition, a base station (BS) may indicate an advanced base station (ABS), a high reliability base station (HR-BS), a node B, an evolved node B, (eNodeB), an access point (AP), a radio access station (RAS), a base transceiver station (BTS), a mobile multihop relay (MMR)-BS, a relay station (RS) serving as the base station, a relay node (RN) serving as the base station, an advanced relay station (ARS) serving as the base station, a high reliability relay station (HR-RS) serving as the base station, small base stations [femto base station (femto BS), a home node B (HNB), a home eNodeB (HeNB), a pico base station (pico BS), a metro base station (metro BS), a micro base station (micro BS), and the like], or the like, and may include all or some of functions of the ABS, the node B, the eNodeB, the AP, the RAS, the BTS, the MMR-BS, the RS, the RN, the ARS, the HR-RS, the small base stations, or the like.

Hereinafter, a low latency transmission method and apparatus according to an exemplary embodiment of the present invention will be described in detail with reference to the accompanying drawings.

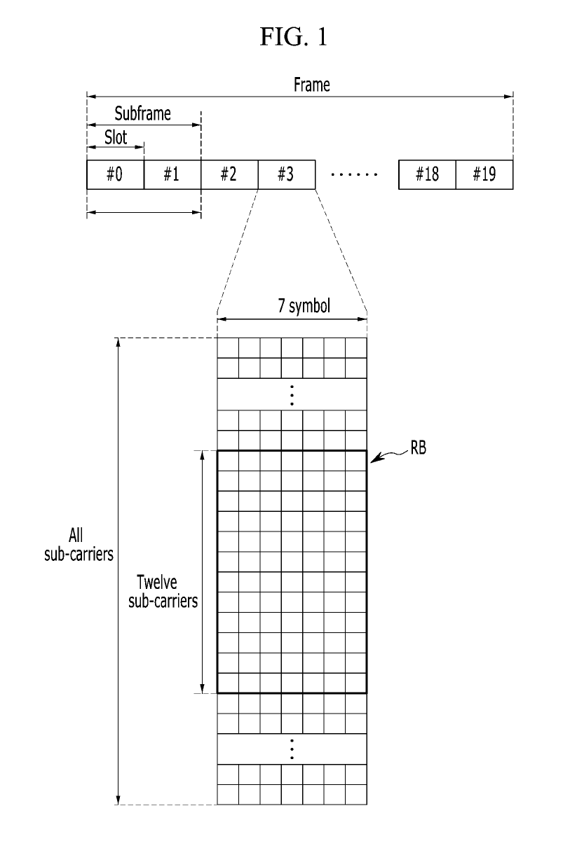

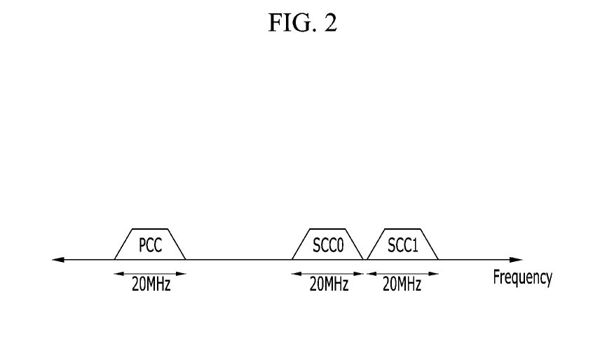

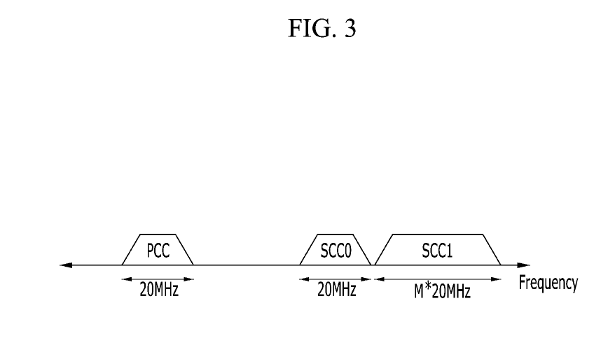

FIG. 1 is a view showing an example of a frame structure of a legacy long term evolution (LTE) system, and FIGS. 2 and 3 are views showing an example of a multi-component carrier supported by the legacy LTE system, respectively.

Referring to FIG. 1, in a legacy long term evolution (LTE) system, which is a typical mobile communication system, one frame has a length of 10ms in a time domain, and includes twenty slots #0 to #19 having a length of 0.5 ms.

One subframe has a length of 1 ms, and includes two slots. Each slot includes a plurality of symbols in the time domain, and includes a plurality of sub-carriers in a frequency domain. The symbol may be called an orthogonal frequency division multiplex (OFDM) symbol, an OFDMA symbol, a single carrier-frequency division multiple access (SC-FDMA) symbol, or the like, depending on a multiple access scheme. The number of symbols included in one slot may be variously changed depending on a channel bandwidth or a length of a cyclic prefix (CP). For example, in the case of a normal CP, one slot includes seven symbols, but in the case of an extended CP, one slot includes six symbols.

In the legacy LTE system, a minimum unit of a time resource for transmitting data is defined as a transmission time interval (TTI). The TTI is set to be the same as a length of one subframe. That is, the TTI has a length of 1 ms. In addition, a resource block (RB) which is a basic unit for transmitting data in a physical layer, includes a plurality of symbols and a plurality of sub-carriers. For example, in the case of the normal CP, the RB may include twelve sub-carriers and seven symbols.

In the legacy LTE system, a maximum operation bandwidth of one component carrier is 20 MHz, and an actual transmission bandwidth of one component carrier is 18 MHz. A remaining frequency bandwidth except for the actual transmission bandwidth may be used as a protection band. Therefore, in a used band in the actual transmission bandwidth, a sub-carrier interval may be set to 15 kHz, a bandwidth of one RB may become about 180 kHz, and at most 100 RBs may be included in the used band. Here, the number of RBs may be changed depending on an operation bandwidth. A sampling rate is set to 30.72 MHz, and a time required for transmitting one sample is 0.326 μs. A fast Fourier transform (FFT) size is set to 2048. A length of one subframe is 30720*Ts, and Ts is 1/(15000*2048)s.

One symbol includes a CP and an effective symbol section, and the CP includes 160 or 144 samples. Therefore, a transmission time (or length) of the CP having 144 samples is 4.69μm, and a transmission time of the effective symbol section including 2048 samples is 66.67 μs.

As described above, the legacy LTE system is operated at a sampling rate of 30.72 MHz, and supports scalable bandwidths such as 1.4 MHz, 3 MHz, 5 MHz, 10 MHz, 15 MHz, 20 MHz, and the like. In addition, the legacy LTE system may support a multi-component carrier system using carrier aggregation. The multi-component carrier system may aggregate component carriers having a bandwidth supported by the LTE system using the carrier aggregation to support a wider bandwidth. As a bandwidth of the component carrier, a bandwidth used in the legacy LTE system may be used as it is or a bandwidth that is an integer times of a bandwidth used in the legacy LTE system may be used for the purpose of backward compatibility with the legacy LTE system.

As shown in FIGS. 2 and 3, magnitudes of bandwidths of the component carriers used for carrier aggregation may be the same as or different from each other. A wide band may be configured using component carriers of a bandwidth (20 MHz) supported by the legacy LTE system as shown in FIG. 2 or be configured using component carriers of the bandwidth (20 MHz) supported by the legacy LTE system and a new bandwidth (M*20 MHz) as shown in FIG. 3. Here, M is an integer number. That is, the new bandwidth (M*20 MHz) may be set to an integer times of the bandwidth (20 MHz) supported by the legacy LTE system.

In addition, the component carriers used for the carrier aggregation have different frequency bandwidths (or central frequencies). In addition, the component carriers used for the carrier aggregation may be present on a continuous frequency bandwidth or be present on a discontinuous frequency bandwidth.

The component carriers used for the carrier aggregation may be classified into one primary component carrier (PCC) and one or more secondary component carriers SCC0 and SCC1. The primary component carrier (PCC) may also be called a primary cell (PCell), and the secondary component carriers SCC0 and SCC1 may also be called secondary cells (SCells).

The terminal may use only one primary component carrier (PCC) or use one or more secondary component carriers SCC0 and SCC1 together with the primary component carrier (PCC). The terminal may receive the primary component carrier (PCC) and/or the secondary component carriers SCC0 and SCC1 allocated from the base station.

The numbers of component carriers aggregated in a downlink and an uplink may be set to be different from each other. The component carriers aggregated in the downlink are called downlink component carriers, and the component carriers aggregated in the uplink are called uplink component carriers. The case in which the number of downlink component carriers and the number of uplink component carriers are the same as each other is called symmetric aggregation, and the case in which the number of downlink component carriers and the number of uplink component carriers are different from each other is called asymmetric aggregation. The unlink component carriers and the downlink component carriers may have different frequency bandwidths.

The legacy LTE system uses a TTI (hereinafter, referred to as a “short TTI (sTTI)” shorter than a legacy TTI of 1 ms in order to support low latency. A frame having the legacy TTI is called a legacy frame, and a frame having the sTTI is called a low latency frame.

According to an exemplary embodiment of the present invention, the legacy frame is used in the primary component carriers, and the low latency frame is used in the secondary component carriers. That is, a physical channel in the low latency frame uses a frequency resource different from a frequency resource used in a physical channel in the legacy frame. In addition, since lengths of the legacy TTI and the sTTI are different from each other, a layer 1 (L1) control is performed for each component carrier.

In the low latency frame, a sub-carrier interval may be set to an integer times (15 kHz×M) of a sub-carrier interval of 15 kHz, and an entire system bandwidth may include Z RBs, and one RB may include B sub-carriers.

The sub-carrier interval of 15 kHz×M may constitute a low latency system having a sampling rate of 15×M×2^{Q}. 2^{Q} is an FFT size for calculating a sampling rate.

The low latency system according to an exemplary embodiment of the present invention supports a scalable bandwidth within a maximum bandwidth of the low latency system, and supports secondary component carriers used by only a low latency terminal operated at the sTTI. The short TTI (sTTI) may have 1/K ms, and may include T symbols. A symbol within the sTTI is called a short symbol, which may have a time length of (CP length+2^{Q})/(15*M*2^{Q}).

Tables 1 to 3 show examples of a sub-carrier interval and a maximum bandwidth in the low latency system according to an exemplary embodiment of the present invention, respectively. In Table 1 to Table 3, parameter values of the low latency system are compared with those of an LTE system, respectively.

TABLE 1

| | | Low Latency |
|---|---|---|
| | Legacy LTE system | System M = 2 |
| Sub-carrier Interval | 15 kHz | 15 × M = 30 kHz |
| Number of Sub- | 1RB = 12 SC | 1RB = 12SC |
| carriers within | 1RB = 15 kHz × 12 = | 1RB = 30 kHz × 12 = |
| 1 RB | 180 kHz | 360 kHz |
| Sampling Rate | 15 kHz × 2048 = | (15 kHz × 2) × 1024 = |
| | 30.72 MHz | 30.72 MHz |
| Maximum Bandwidth | 20 MHz | 20 MHz |
| All RBs, Resource | 18 MHz | 18 MHz, 600RB |
| Bandwidth (RB) | | |
| CP length | 160, 144 samples | 256 samples |
| Number of Symbols | 14 symbol | 6 symbol |
| in 1 (s)TTI | | |
| Length of 1 (s)TTI | 1 ms, 30720 samples | 250 us, 7680 samples |

TABLE 2

| | | Low Latency |
|---|---|---|
| | Legacy LTE system | system M = 4 |
| Sub-carrier Interval | 15 kHz | 15 kHz × 4 = 60 Hz |
| | | M = 4 |
| Number of Sub- | 1RB = 12SC | 1RB= 12SC |
| carriers within | 1RB = 15 kHz × 12 = | 1RB = 15 kHz × M × 12 |
| 1 RB | 180 kHz | (720 kHz) |
| Sampling Rate | 15 kHz × 2048 = | (15 kHz × M) × 512 |
| | 30.72 MHz | (30.72 MHz) |
| Maximum Bandwidth | 20 MHz | 20 MHz |
| All RBs, Resource | 18 MHz | 18 MHz |
| Bandwidth (RB) | | |
| CP length | 160, 144 samples | 128 samples |
| Number of Symbols | 14 symbol | 12 symbol |
| in 1 (s)TTI | | |
| Length of 1 (s)TTI | 1 ms, 30720 samples | 250 us, 7680 samples |

TABLE 3

| | | Low Latency |
|---|---|---|
| | Legacy LTE system | system M = 4 |
| Sub-carrier Interval | 15 kHz | 15 kHz × M M = 4 |
| Number of Sub- | 1RB = 12 SC | 1RB = 12SC |
| carriers within | 1RB = 15 kHz × 12 = | 1RB = 15 kHz × M × 12 |
| 1 RB | 180 kHz | (720 kHz) |
| Sampling Rate | 15 kHz × 2048 = | (15 kHz × M) × 1024 |
| | 30.72 MHz | (61.44 MHz) |
| Maximum Bandwidth | 20 MHz | 40 MHz |
| All RBs, Resource | 18 MHz | 600SC × 15 kHz |
| Bandwidth (RB) | | (36 MHz) |
| CP length | 160, 144 | 256 |
| Number of Symbols | 14 symbol | 12 symbol |
| in 1 (s)TTI | | |
| Length of 1 (s)TTI | 1 ms. 30720 samples | 250 us, 15360 samples |

As described above, due to a sub-carrier interval extended to an integer times of a sub-carrier interval in the legacy LTE system, a maximum bandwidth of the secondary component carrier supported by the low latency system may have an M times of a maximum bandwidth of the legacy LTE system, and the low latency system may support a scalable bandwidth, similar to the legacy LTE system. Here, M is an integer number larger than 0.

Bandwidths of secondary component carriers shown in Table 1 to Table 3, which are maximum bandwidths of the low latency system, should be able to support scalable bandwidths supported by the legacy LTE system. That is, within a maximum sampling rate and a maximum bandwidth, the number of RBs and a sampling rate may be decreased, similar to the legacy LTE system.

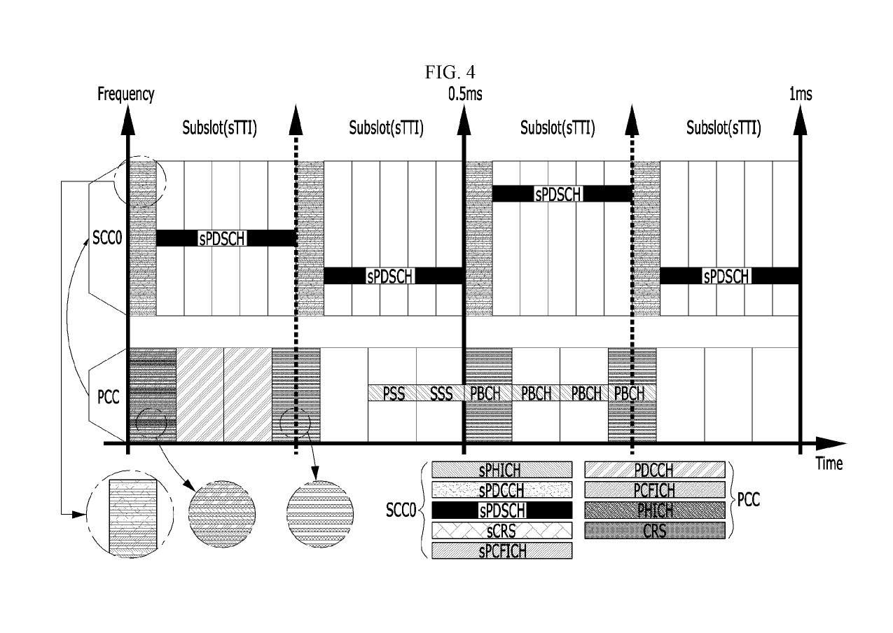

FIG. 4 is a view showing an example of a downlink subframe of a low latency system according to Table 1.

Referring to FIG. 4, in a downlink primary component carrier (PCC), scheduling for transmitting data in a legacy TTI unit is performed, similar to the legacy LTE system, and a synchronization signal and system information are transmitted through the downlink primary component carrier (PCC).

A downlink subframe of the downlink primary component carrier (PCC) may be configured to be the same as a downlink subframe of the legacy LTE system.

The downlink subframe of the downlink primary component carrier (PCC) is divided into a control region and a data region in the time domain. The control region includes at most three symbols of a first slot of a subframe. However, the number of symbols included in the control region may be changed. A downlink control channel may be allocated in the control region, and a downlink data channel may be allocated in the data region.

In the legacy LTE system, there are a physical downlink control channel (PDCCH), a physical control format indicator channel (PCFICH) and a physical hybrid-ARQ indicator channel (PHICH) as the downlink control channel, and there is a physical downlink shared channel (PDSCH) as the downlink data channel. The PCFICH is transmitted in a first symbol of a subframe, and includes a control format indicator (CFI) about the number (that is, a size of the control region) of symbols used for transmission of the control channels within the subframe. Unlike the PDCCH, the PCFICH does not use blind decoding, and is transmitted through resources of a fixed PCFICH of the subframe. The PHICH is transmitted in the first symbol of the subframe, and includes positive-acknowledgement (ACK)/negative-acknowledgement (NACK) signals for an uplink hybrid automatic repeat request (HARQ). ACK/NACK signals for uplink data transmitted by the terminal are transmitted through the PHICH. A physical broadcast channel (PBCH) is transmitted in initial four symbols of a second slot of a first subframe of a wireless frame.

The PBCH carries system information necessary for the terminal to communicate with the base station, and the system information transmitted through the PBCH is called a master information block (MIB). The MIB includes a system bandwidth, a system frame number (SFN), and PHICH setting information. The PHICH setting information may include a PHICH duration and PHICH resources. The PHICH duration indicates the number of symbols in which the PHICH is transmitted. The PHICH resources are used to determine the number of PHICH groups in the sub-frame.

The terminal may receive the MIB transmitted through the PBCH to obtain information on SFN synchronization between the base station and the terminal, PHICH setting, and a system bandwidth.

In the legacy LTE system, a synchronization signal is used at the time of performing cell search, and a primary synchronization signal (PSS) and a secondary synchronization signal (SSS) are used as the synchronization signal. The PSS is transmitted in final symbols of a first slot of a first subframe and a first slot of a sixth subframe, and the SSS is transmitted in symbols immediately before symbols to which the PSS is allocated. The terminal may detect a cyclic prefix (CF) type, wireless frame synchronization, symbol synchronization, and a cell identifier to which the terminal 200 belongs by detecting the PSS and the SSS transmitted from the base station after it is turned on.

The synchronization signal and the PBCH are transmitted within central six RBs in a system bandwidth in the downlink primary component carrier (PCC), such that the terminal may detect or decode the synchronization signal and the PBCH regardless of a transmission bandwidth.

In addition, cell-specific reference signals (CRSs) are transmitted over an entire downlink bandwidth in all downlink subframes in a cell, and are transmitted from all antenna ports of the base station. The CRSs may be allocated to predetermined positions in each RB in all RBs. The CRSs in the time domain may be positioned at predetermined intervals from first symbols of each slot. Time intervals are differently defined depending on a length of the CP. In the case of the normal CP, the CRSs are positioned at first and fifth symbols (I=0 and I=4) of each slot. The CRSs for at most two antenna ports may be defined in one symbol.

The downlink subframe of the downlink secondary component carrier (SCC0) may include four subslots operated in an sTTI unit. A low latency downlink physical channel performing the same function as those of the PDCCH, the PHICH, the PDSCH, and the PCFICH is allocated to each subslot. The PDCCH, the PHICH, the PDSCH, and the PCFICH used in the downlink secondary component carrier (SCC0) are called an sPDCCH, an sPHICH, an sPDSCH, and an sPCFICH, respectively. In addition, a CRS used in the secondary component carrier is called an sCRS.

As shown in Table 1, one subslot in the downlink secondary component carrier (SCC0) may include six short symbols, and may be divided into a control region and a data region in the time domain. The control region includes one short symbol. However, the number of short symbols included in the control region may be changed. The sPDCCH and the sPHICH may be transmitted through a first symbol of the sTTI, and the sPDSCH may be transmitted in the remaining symbols except for the first symbol of the sTTI. The sPDSCH may be demodulated using information received in the sPDCCH, terminal-specific reference signals may be allocated to the sPDSCH, and the terminal may perform channel estimation and measurement for the sPDSCH using the terminal-specific reference signals.

The sCRSs may be transmitted in only the first symbols in each sTTI. Here, the sCRSs may be transmitted from some of all antenna ports of the base station unlike the existing LTE system. That is, the number of antenna ports to which the sCRSs are allocated is decreased. On the other hand, the terminal-specific reference signals may be transmitted in the remaining symbols except for the first symbols in each sTTI. The terminal-specific reference signals may be allocated to correspond to all the antenna ports of the base station. The sCRS may be used for demodulation of the sPDCCH and the sPHICH, and may also be used for measurement of a signal to interference plus noise ratio (SINR) for scheduling the downlink secondary component carrier (SCC0). A measurement result in a bandwidth of the downlink secondary component carrier may be transmitted through the uplink component carrier.

In an initial access step between the terminal and the base station, the base station performs a random access procedure using the legacy TTI in the downlink primary component carrier (PCC). After a connection between the terminal and the base station is made, the base station commands the terminal to allocate resources to a bandwidth allocated to the downlink secondary component carrier SCC0 supporting the low latency, and resource allocation information in the sTTI in the downlink secondary component carrier SCC0 may be transmitted to the terminal through the sPDCCH.

Time synchronization between the legacy TTI in the downlink primary component carrier (PCC) and the sTTI in the downlink secondary component carrier SCC0 is made, and a resource allocation instruction and an L1 control instruction may be transmitted to the downlink secondary component carrier SCC0 at a boundary point of the legacy TTI of the downlink primary component carrier (PCC). A control from the downlink primary component carrier (PCC) to the downlink secondary component carrier (SCC0) is performed on the basis of the subframe in the downlink primary component carrier (PCC).

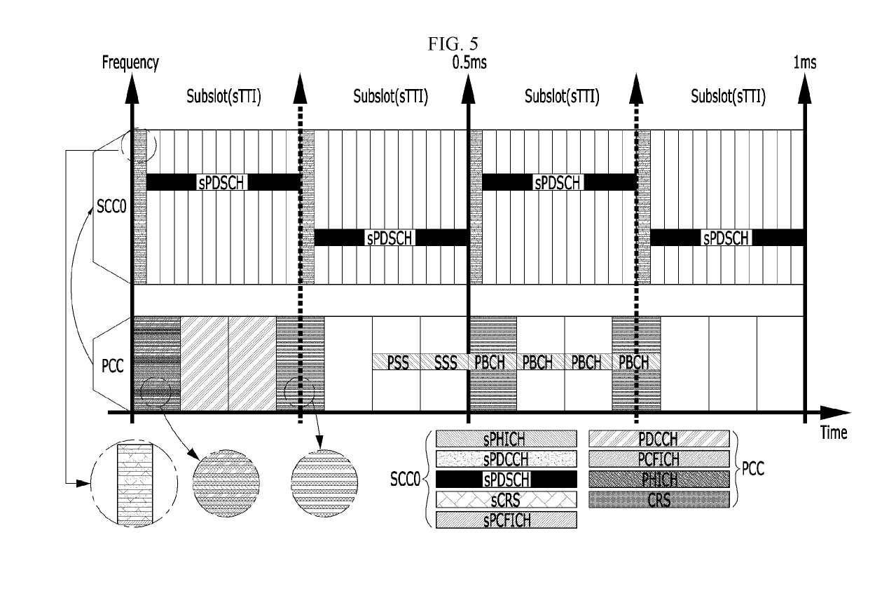

FIG. 5 is a view showing an example of a downlink subframe of a low latency system according to Table 2 and Table 3.

Referring to FIG. 5, the downlink subframe of the downlink secondary component carrier (SCC0) may include four subslots operated in the sTTI unit. As shown in Table 2 and Table 3, one subslot in the secondary component carrier may include twelve short symbols, and may be divided into a control region and a data region in the time domain. The control region may include one short symbol. An sPDCCH, an sPHICH, and an sPCFICH may be allocated to the control region, and an sPDCCH may be allocated to the data region.

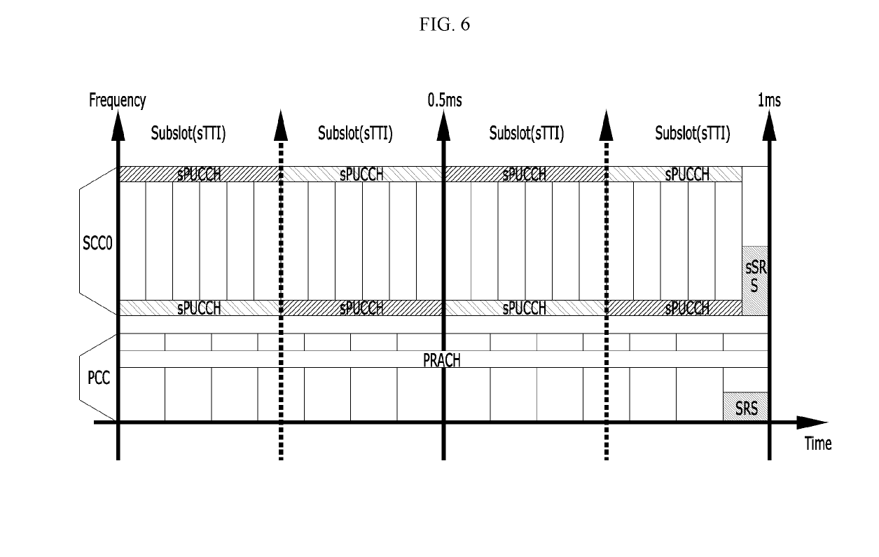

FIG. 6 is a view showing an example of an uplink subframe of a low latency system according to Table 1.

Referring to FIG. 6, the uplink subframe of the uplink primary component carrier (PCC) may be divided into control regions and a data region in the frequency domain. The control regions are positioned at both ends of the system bandwidth, and a physical uplink control channel (PUCCH) (not shown) for transmitting uplink control information is allocated to the control regions. The PUCCH carries various kinds of control information depending on a format. PUCCH format 1 carries Scheduling Request. PUCCH formats 1a and 1b carry ACK/NACK, and PUCCH format 2 carries a modulated channel quality indicator (CQI). A physical uplink shared channel (PUSCH) for transmitting data is allocated to the data region. In addition, a physical random access channel (PRACH) may be allocated over the time domain. The PRACH transmits a random access preamble. As described above, the random access preamble through the PRACH at the time of a random access procedure may be transmitted through the uplink primary component carrier (PCC). A sounding reference signal (SRS) may be transmitted through the last symbol in one subframe. The SRSs of several terminals transmitted through the last symbol of the same subframe may be distinguished from each other depending on frequency positions and sequences.

The uplink subframe of the uplink secondary component carrier (SCC0) may include four subslots operated in an sTTI unit. A low latency uplink physical channel performing the same function as those of the PUCCH and the PUSCH is allocated to each subslot. The PUCCH and the PUSCH used in the uplink secondary component carrier (SCC0) are called an sPUCCH and an sPUSCH, respectively. In addition, an SRS used in the secondary component carrier (SCC0) is called an sSRS.

As shown in Table 1, one subslot may include six short symbols, and may be divided into a control region and a data region in the frequency domain. The sPUCCH may be allocated to the control region, and the sPUSCH may be allocated to the data region. Resource allocation of the sPUSCH is performed through downlink control information (DCI) of the sPDCCH. In addition, the sSRS may be transmitted through the last symbol of the uplink subframe, similar to the SRS of the primary component carrier, and is used in order to figure out channel characteristics of uplink resources of the uplink secondary component carrier (SCC0).

The uplink resources of the uplink secondary component carrier (SCC0) are allocated through the downlink primary component carrier, and uplink synchronization and an initial access between the base station and the terminal may be performed through the uplink primary component carrier.

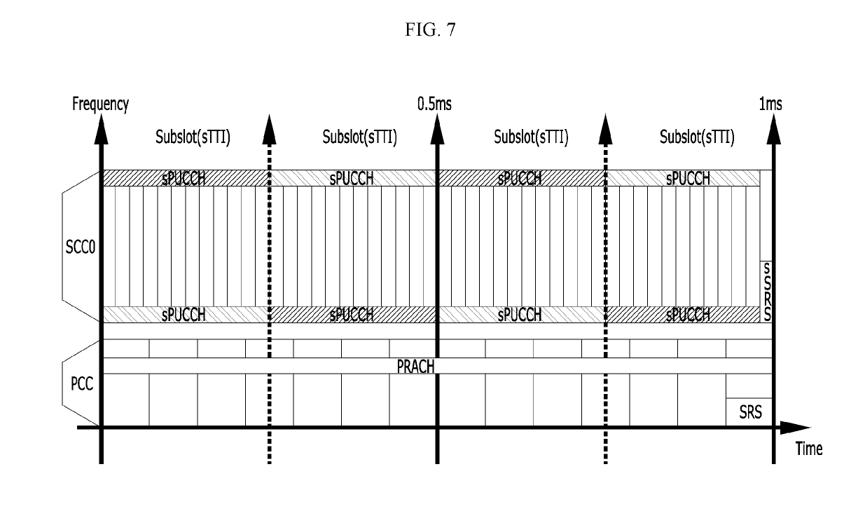

FIG. 7 is a view showing an example of an uplink subframe of a low latency system according to Table 2 and Table 3.

Referring to FIG. 7, the uplink subframe of the uplink secondary component carrier (SCC0) may include four subslots operated in the sTTI unit.

As shown in Table 2 and Table 3, one subslot in the secondary component carrier (SCC0) may include twelve short symbols, and may be divided into a control region and a data region in the frequency domain. The sPUCCH may be allocated to the control region, and the sPUSCH may be allocated to the data region. In addition, the sSRS may be transmitted through the last symbol of the uplink subframe.

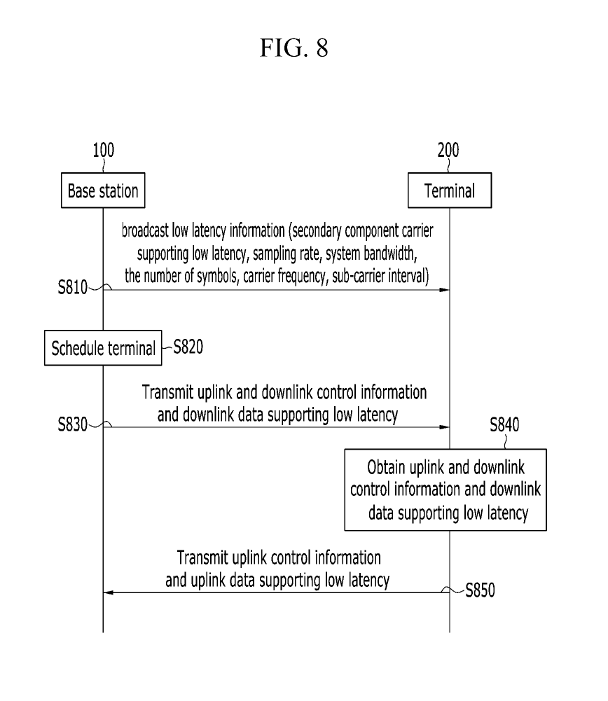

FIG. 8 is a view showing a low latency transmission method according to an exemplary embodiment of the present invention.

Referring to FIG. 8, a base station 100 periodically broadcasts low latency information to all terminals 100 within a cell (S810). The low latency information may include information on a secondary component carrier supporting low latency. The information on the secondary component carrier supporting the low latency may include a carrier frequency, the number of symbols, a sub-carrier interval, a sampling rate, a system bandwidth, the number of transmitting antennas used in a low latency mode, and the like.

When the terminal 200 is connected to the base station 100 through an initial access procedure, the terminal 200 receives the low latency information broadcast by the base station 100 in order to support low latency terminals within the cell.

The base station 100 recognizes that the terminal 200 is a low latency terminal of which a low latency service is possible through terminal information transmitted from the terminal 200 at the time of an initial access, and performs scheduling for transmitting and receiving low latency data to and from the terminal 200 (S820).

The base station 100 transmits uplink and downlink control information and downlink data through downlink subslots transmitted in the sTTI unit shown in FIGS. 4 and 5 (S830). The uplink and downlink control information may be transmitted through the sPDCCH, and the downlink data may be transmitted through the sPDSCH. The downlink control information may include a resource position of the sPDSCH in the downlink secondary component carrier, frequency hopping information, whether or not a terminal-specific reference signal is present, the number of antennas, the number of layers, information on a pre-coding matrix. In addition, the uplink control information may include uplink resource allocation information in the uplink secondary component carrier, uplink power control, the numbers of transmitting antennas and layers to the uplink, and pre-coding information.

The terminal 200 obtains the uplink and downlink control information and the downlink data through the downlink subslots (S840).

Then, the terminal 200 may transmit the uplink control information and the uplink data through the uplink subslots in the uplink secondary component carrier using the uplink control information (S850).

As described above, the base station 100 may allocate resources of a low latency physical channel while supporting the low latency service appropriate for the terminal 200.

Meanwhile, the terminal 200 may use a low latency mode in only a specific region, and the terminal 200 entering the specific region may request a low latency connection in order to be connected to the base station 100 in the low latency mode. In this case, a time required for the base station 100 and the terminal 200 to enter the low latency mode therebetween may be saved.

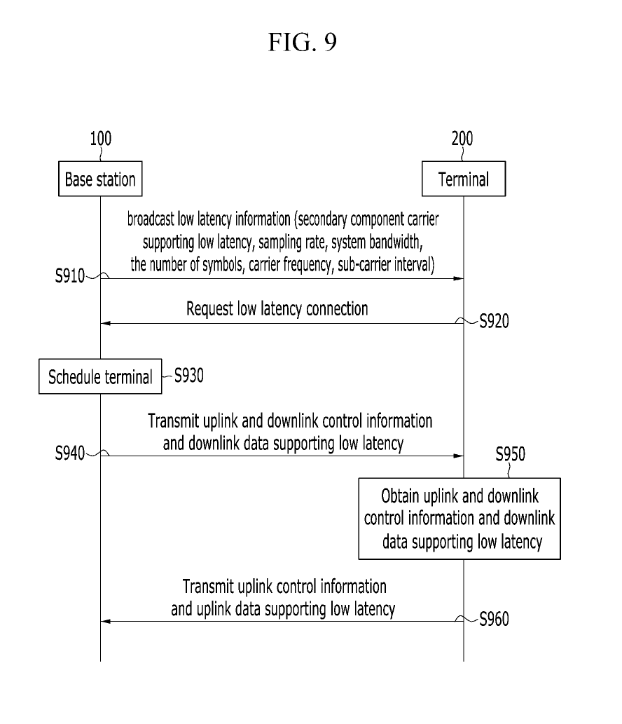

FIG. 9 is a view showing a low latency transmission method according to another exemplary embodiment of the present invention.

Referring to FIG. 9, when the terminal 200 is connected to the base station 100, the terminal 200 receives low latency information broadcast from the base station 100 (S910).

The terminal 200 for being operated in a low latency mode transmits a low latency connection request to the base station 100 (S920).

The base station 100 receiving the low latency connection request may perform scheduling for transmitting and receiving low latency data to and from the terminal 200 (S930).

Next, the base station 100 transmits uplink and downlink control information and downlink data through downlink subslots transmitted in the sTTI unit shown in FIGS. 4 and 5 (S940).

The terminal 200 obtains the uplink and downlink control information and the downlink data through the downlink subslots (S950).

Then, the terminal 200 may transmit the uplink control information and the uplink data through the uplink subslots in the uplink secondary component carrier using the uplink control information (S960).

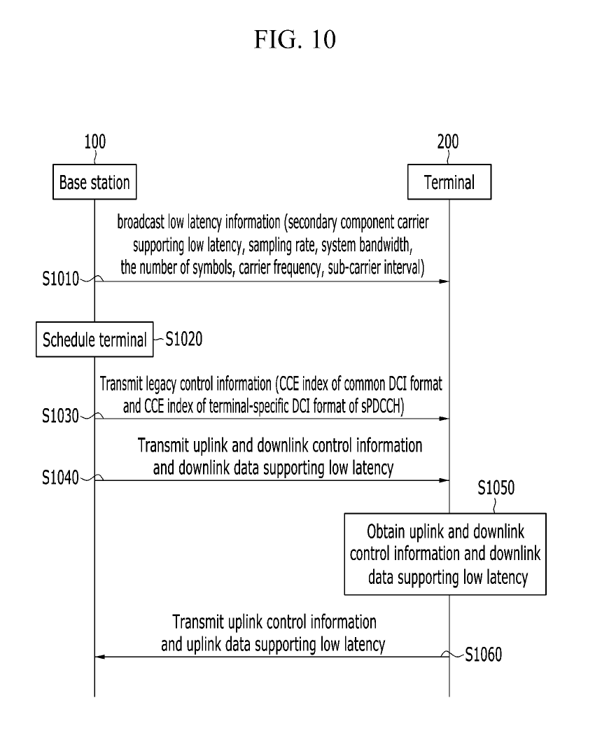

FIG. 10 is a view showing a low latency transmission method according to another exemplary embodiment of the present invention.

Referring to FIG. 10, when the terminal 200 is connected to the base station 100, the terminal 200 receives low latency information broadcast from the base station 100 (S1010).

The base station 100 recognizes that the terminal 200 is a low latency terminal of which a low latency service is possible, and performs scheduling for transmitting and receiving low latency data to and from the terminal 200 (S1020).

The base station 100 transmits information of a secondary component carrier supporting low latency in the downlink primary component carrier to the terminal 200. The terminal 200 may be operated in a low latency mode in the secondary component carrier supporting the low latency on the basis of the information of the secondary component carrier supporting the low latency.

In detail, the base station 100 may transmit control channel element (CCE) index and size information of a common downlink control information (DCI) format and CCE index and size information of a terminal-specific DCI format of the sPDCCH through the PDCCH of the legacy frame in the downlink primary component carrier to the terminal 200 (S1030). A CCE indicates a basic unit of transmission resources when the DCI is transmitted through the PDCCH. One CCE may include nine resource element groups (REGs), and one REG may include four resource elements (REs).

In the legacy LTE system, the PDCCH is divided into a common DCI region and a terminal-specific DCI region. A common DCI format indicates a DCI format applied in common to all terminals within the cell, and a terminal-specific DCI format indicates a DCI format applied to a specific terminal. The sPDCCH may also be divided into a common DCI region and a terminal-specific DCI region, similar to the PDCCH. Resource allocation information of the sPUCCH may be periodically or aperiodically transmitted through the downlink primary component carrier.

An index of REGs of the common DCI region within the sPDCCH may be changed per sTTI. After a terminal-specific DCI region is also allocated for each terminal, an index of REGs may be changed per sTTI, and a control from the downlink primary component carrier to the downlink secondary component carrier may start on the basis of the subframe in the downlink primary component carrier.

As described above, the base station 100 transmits resource positions of the sPDCCH to the terminal 200 through the control information in the downlink primary component carrier. Therefore, the terminal 200 may not perform blind detection with respect to the control information of the terminal 200 transmitted through the sPDCCH unlike PDCCH demodulation of the downlink primary component carrier.

In addition, the number of symbols allocated to the sPDCCH may be detected by demodulating the sPCFICH, and then the sPDCCH may be detected using an RNTI value as in the PDCCH of the downlink primary component carrier.

Next, the base station 100 transmits uplink and downlink control information and downlink data through downlink subslots transmitted in the sTTI unit shown in FIGS. 4 and 5 (S1040).

The terminal 200 demodulates the sPDCCH on the basis of the CCE index and size information of the DCI format of the sPDCCH and demodulates downlink data using the control information in the sPDCCH to obtain the uplink and downlink control information and the downlink data through the downlink subslot (S1050).

Then, the terminal 200 may transmit the uplink control information and the uplink data through the uplink subslots in the uplink secondary component carrier using the uplink control information (S1060).

As described above, the terminal 200 operated in the low latency mode may request a low latency connection release within the secondary component carrier and request a low latency connection release through the primary component carrier in order to stop the low latency mode.

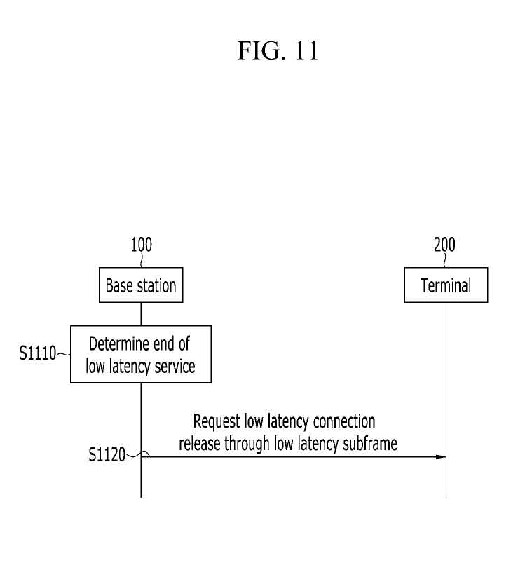

FIGS. 11 to 14 are views showing a low latency service ending method according to an exemplary embodiment of the present invention, respectively.

Referring to FIG. 11, when the base station 100 determines an end of a low latency service (S1110), the base station requests a low latency connection release through the control information of the sPDCCH to the terminal 200 operated in the low latency mode (S1120).

The terminal 200 ends the low latency mode in the secondary component carrier when it receives the request for the low latency connection release. The terminal 200 ending the low latency mode may request a scheduling request (SR) to the base station 100 or receive paging information from the base station 100 in the uplink primary component carrier to be switched into a connection mode within the primary component carrier.

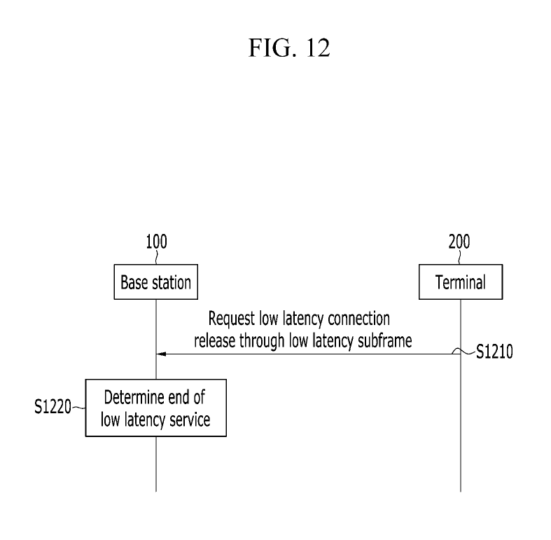

Unlike this, as shown in FIG. 12, the terminal 200 operated in the low latency mode in the secondary component carrier may request a low latency connection release to the base station 100 through the control information of the sPUCCH (S1210).

When the base station 100 receives the request for the low latency connection release from the terminal 200, the base station 100 ends the low latency service (S1220). As described above, the terminal 200 ending the low latency mode may request a scheduling request (SR) to the base station 100 or receive paging information from the base station 100 in the primary component carrier to be switched into a connection mode within the primary component carrier.

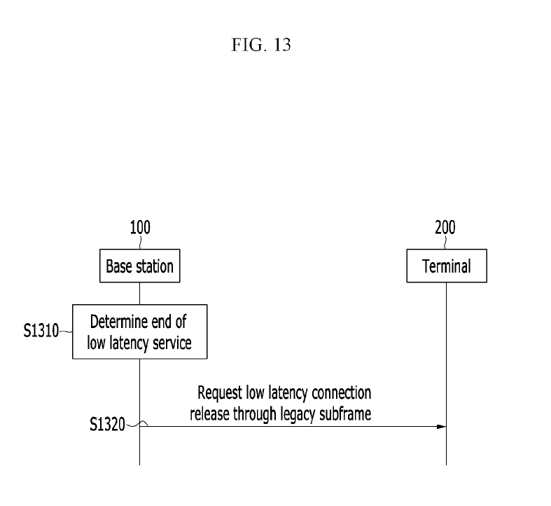

In addition, referring to FIG. 13, when the base station 100 determines an end of a low latency service (S1310), the base station 100 may request a low latency connection release to the terminal 200 operated in the low latency mode through the control information of the PDCCH legacy subframe in the downlink primary component carrier (S1320).

The terminal 200 ends the low latency mode in the secondary component carrier when it receives the request for the low latency connection release.

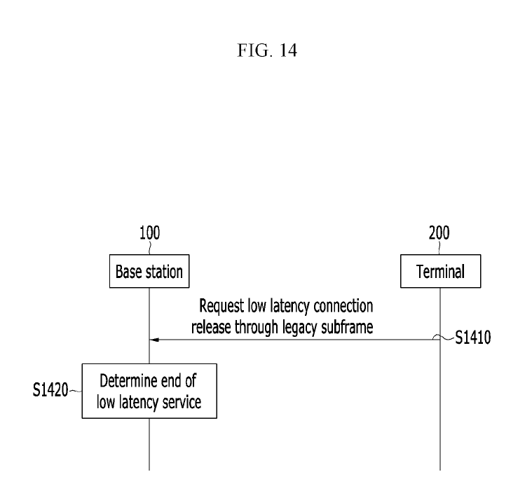

Meanwhile, as shown in FIG. 14, the terminal 200 operated in the low latency mode in the secondary component carrier may request a low latency connection release to the base station 100 through the control information of the PUCCH legacy subframe in the primary component carrier (S1410).

When the base station 100 receives the request for the low latency connection release from the terminal 200, the base station 100 ends the low latency service (S1420).

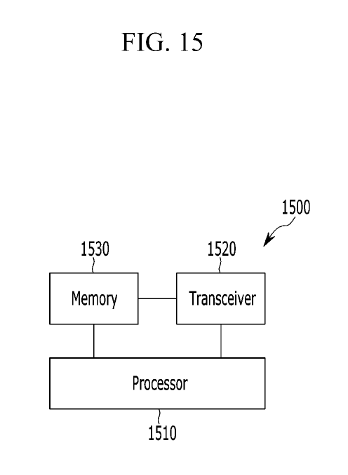

FIG. 15 is a view showing a low latency transmission apparatus of a base station according to an exemplary embodiment of the present invention.

Referring to FIG. 15, a low latency transmission apparatus 1500 of the base station 100 includes a processor 1510, a transceiver 1520, and a memory 1530.

The processor 1510 may perform functions of the base station 100 described on the basis of FIGS. 8 to 14. The processor 1510 may allocate a primary component carrier and at least one secondary component carrier that are to be used by the terminal and may perform a resource allocation function for physical channels within the primary component carrier and the secondary component carrier. The processor 1510 may support the low latency mode of the terminal, and allocate the secondary component carrier for supporting the low latency for the purpose of the low latency mode of the terminal.

The transceiver 1520 is connected to the processor 1510 and transmits and receives wireless signals to and from the terminal. The transceiver 1520 may include a base band processor (not shown) for each component carrier for processing wireless signals of each component carrier.

The memory 1530 stores instructions that are to be executed in the processor 1510 therein or loads instructions from a storage device (not shown) and temporarily stores the loaded instructions therein, and the processor 1510 executes the instructions stored or loaded in the memory 1530.

The processor 1510 and the memory 1530 are connected to each other through buses (not shown), and input and output interfaces (not shown) may also be connected to the buses. Here, the transceiver 1520 may be connected to the input and output interfaces, and peripheral devices such as an input device, a display, a speaker, a storage device, and the like, may be connected to the input and output interfaces.

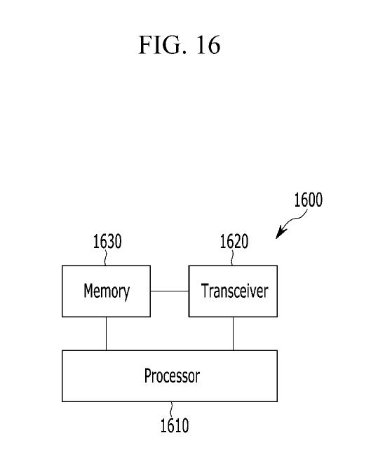

FIG. 16 is a view showing a low latency transmission apparatus of a terminal according to an exemplary embodiment of the present invention.

Referring to FIG. 16, a low latency transmission apparatus 1600 of the terminal 200 includes a processor 1610, a transceiver 620, and a memory 1630.

The processor 1610 may perform functions of the terminal 200 described on the basis of FIGS. 8 to 14. The processor 1610 receives the primary component carrier and at least one secondary component carrier allocated from the base station, and transmits and receives data to and from the base station on the basis of resource allocation information on physical channels within the primary component carrier and the secondary component carrier. Particularly, the processor 1610 may be operated in the low latency mode on the basis of the resource allocation information of the secondary component carrier for supporting the low latency.

The transceiver 1620 is connected to the processor 1610 and transmits and receives wireless signals to and from the base station. The transceiver 1620 may include a base band processor (not shown) for each component carrier for processing wireless signals of each component carrier.

The memory 1630 stores instructions that are to be executed in the processor 1610 therein or loads instructions from a storage device (not shown) and temporarily stores the loaded instructions therein, and the processor 1610 executes the instructions stored or loaded in the memory 1630.

The processor 1610 and the memory 1630 are connected to each other through buses (not shown), and input and output interfaces (not shown) may also be connected to the buses. Here, the transceiver 1620 may be connected to the input and output interfaces, and peripheral devices such as an input device, a display, a speaker, a storage device, and the like, may be connected to the input and output interfaces.

According to an exemplary embodiment of the present invention, a legacy TTI of 1 ms is used in a primary component carrier in order to support a legacy service, and a short TTI is used in a secondary component carrier using a frequency resource different from that of the primary component carrier in order to support a low latency service, thereby making it possible to divide a processing clock of a modem processing one component carrier into the legacy service and the low latency service and increase a processing speed of a modem processing a component carrier depending on an increase in a sampling rate for the low latency service. In addition, since an L1 control is differently performed for each component carrier due to a problem that lengths of a short TTI and a legacy TTI are different from each other, the L1 control may be simpler than that of a scheme of simultaneously transmitting the legacy TTI and the short TTI, and resources for the low latency service and resources for the legacy service are separately used, thereby making it possible to increase data rates of the short TTI and the legacy TTI.

Further, a resource ratio occupied by existing signals in a short TTI structure may be minimized, and particularly in the case of allocating a CRS to only a first symbol within a short TTI, terminal-specific reference signals may be allocated to the remaining symbols, such that a resource utilization ratio may be increased.

Further, since uplink and downlink communication may be performed using only a low latency mode after an initial access and the low latency mode are set using a primary component carrier, transmission latency of an uplink and a downlink may be decreased.

Exemplary embodiments of the present invention described above are not implemented through only the apparatus and/or the method described above, but may also be implemented through a program executing functions corresponding to configurations of exemplary embodiments of the present invention or a recording medium in which the program is recorded. In addition, this implementation may be easily made by those skilled in the art to which the present invention pertains from exemplary embodiments described above.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A low latency transmission method in a base station, comprising:
supporting a low latency mode of a terminal through a legacy downlink subframe transmitted in a first transmission time interval (TTI) unit in a downlink primary component carrier; and
transmitting control information and low latency downlink data to the terminal operated in the low latency mode through a downlink subslot transmitted in a second TTI unit in a downlink secondary component carrier.

2. The low latency transmission method of claim 1, wherein:
the second TTI is shorter than the first TTI.

3. The low latency transmission method of claim 1, wherein:
a sampling rate in the downlink secondary component carrier is set to an integer times of a sampling rate in the downlink primary component carrier, and a sub-carrier interval and a system bandwidth in the downlink secondary component carrier are set to integer times of a sub-carrier interval and a system bandwidth in the downlink primary component carrier, respectively.

4. The low latency transmission method of claim 1, wherein:
a time length of the legacy downlink subframe includes a plurality of downlink subslots, and each of the plurality of downlink subslots includes a plurality of short symbols, and
the transmitting includes allocating a cell-specific reference signal to a first symbol among the plurality of short symbols.

5. The low latency transmission method of claim 4, wherein:
the transmitting further includes allocating a terminal-specific reference signal to the remaining symbols except for the first symbol among the plurality of short symbols.

6. The low latency transmission method of claim 1, further comprising:
transmitting a synchronization signal and system information through the downlink primary component carrier.

7. The low latency transmission method of claim 1, wherein:
the supporting includes transmitting low latency information through a control channel of the legacy downlink subframe, and
the low latency information includes at least one of a carrier frequency of a secondary component carrier, the number of symbols within the second TTI unit, a sub-carrier interval, a sampling rate, and a system bandwidth.

8. The low latency transmission method of claim 1, further comprising:
transmitting a low latency connection release requesting turn-off the low latency mode of the terminal through the legacy downlink subframe or the downlink subslot.

9. The low latency transmission method of claim 1, further comprising:
receiving a low latency connection release for informing the base station of turn-off of the low latency mode from the terminal through a legacy uplink subframe transmitted in the first TTI unit from the terminal or an uplink subslot transmitted in the second TTI unit from the terminal.

10. The low latency transmission method of claim 1, further comprising:
receiving control information and low latency uplink data through an uplink subslot transmitted in the second TTI unit in an uplink secondary component carrier from the terminal.

11. The low latency transmission method of claim 10, wherein:
a time length of a legacy uplink subframe transmitted in the first TTI unit includes a plurality of uplink subslots, and each of the plurality of uplink subslots includes a plurality of short symbols, and
the receiving includes receiving a sounding reference signal (SRS) through the last short symbol of the last uplink subslot among the plurality of uplink subslots.

12. A low latency transmission method in a terminal, comprising:
receiving low latency information for a low latency mode of the terminal through a legacy downlink subframe transmitted in a first TTI unit in a downlink primary component carrier from a base station; and
obtaining control information and low latency downlink data through a downlink subslot transmitted in a second TTI unit in a downlink secondary component carrier using the low latency information.

13. The low latency transmission method of claim 12, further comprising:
transmitting control information and low latency uplink data to the base station through an uplink subslot transmitted in the second TTI unit in an uplink secondary component carrier from the terminal.

14. The low latency transmission method of claim 13, wherein:
the transmitting of the control information and the low latency uplink data to the base station includes transmitting an SRS through the last short symbol of the last uplink subslot among a plurality of uplink subslots included in a time length of a legacy uplink subframe transmitted in the first TTI unit.

15. The low latency transmission method of claim 12, wherein:
a time length corresponding to the legacy downlink subframe includes a plurality of downlink subslots.

16. The low latency transmission method of claim 12, wherein:
a sampling rate in the downlink secondary component carrier is set to an integer times of a sampling rate in the downlink primary component carrier, and a sub-carrier interval and a system bandwidth in the downlink secondary component carrier are set to integer times of a sub-carrier interval and a system bandwidth in the downlink primary component carrier, respectively.

17. The low latency transmission method of claim 12, wherein:
the low latency information includes at least one of a carrier frequency of a secondary component carrier, the number of symbols within the second TTI unit, a sub-carrier interval, a sampling rate, and a system bandwidth.

18. The low latency transmission method of claim 12, wherein:
the obtaining includes:
receiving position and size information of a common downlink control information (DCI) region and position and size information of terminal-specific DCI within a control channel of the downlink subslot from the base station; and
receiving common DCI and terminal-specific DCI on the basis of the position and size information of the common DCI region and the position and size information of the terminal-specific DCI.

19. A low latency transmission apparatus comprising:
a processor performing scheduling for transmitting data in a first TTI unit in a primary component carrier, performing scheduling for transmitting data in a second TTI unit in a secondary component carrier, and performing resource allocation for uplink and downlink physical channels for the primary component carrier and the secondary component carrier; and
a transceiver transmitting data and uplink and downlink resource allocation information through the primary component carrier or the secondary component carrier,
wherein the second TTI unit is shorter than the first TTI unit.

20. The low latency transmission apparatus of claim 19, wherein:
a time length of one subframe includes a plurality of subslots,
the first TTI unit is set to the time length of the one subframe, and the second TTI unit is set to a time length of one subslot, and
the processor allocates a cell-specific reference signal (CRS) to a first short symbol among a plurality of short symbols of each subslot in a downlink.
